(19) United States
(12) Patent Application Publication
(10) Pub. No.: US 2004/0079178 A1
(43) Pub. Date: Apr. 29, 2004

(54) Gyro-dipole of variable rotary freedom degree for measure, control and navigation, for sustaining reversible torque stop

(76) Inventor: Vladislav Vasilyevich Gorshkov, Alexandria, VA (US)

Correspondence Address: Vladislav Gorshkov, 3434 A Holly Road, Anandale, VA, 22003, US

(21) Appl. No.: 10/281,515

(22) Filed: Oct. 28, 2002

(51) Int. Cl. G01C 19/54

(52) U.S. Cl. 74/5.4

(57) ABSTRACT

The new gyroscopic device (gyro-dipole) has two gyroscopes with equal angular momentum (gyro-twins) set in a common case with precession axis's disposed parallel and engaged via gears allowing gyro-twins to precess synchronical but contrary. This brings the gyro-dipole through different main axis's positions:

directed opposite and arrested,

directed opposite not arrested,

tilted each to other,

directed equal.

Respectively the gyro-dipole possesses rotary freedom degrees 3, 2, 0, 1. The most interesting value 2, which allows to keep the gyro-dipole motionless about single axis. For terrestrial applications it eliminates Earth revolution negative influence originating:

devices for absolute and relative angular shift detectors, gyro-clock;

methods determining: ground surface deforming vibrations, Earth (planet) spin rate, a place latitude, shortest routs for navigating, values of solid angles countered upon sphere;

method sustaining reversible torque stop for floating power production.

### CROSS-REFERENCE TO RELATED APPLICATIONS

The invention has no analogues.

### STATEMENT REGARDING FEDERALLY SPONSORED R & D

The author created the invention by himself with own means in duty free time.

### REFERENCE TO A MICROFICHE APPENDIX

Not Applicable.

### BACKGROUND OF THE INVENTION

Endeavor: Multiple applications of gyroscopes in control and navigating systems say about their importance. However an ordinary gyroscope has two axis's restricting its inclinations that limits its use in the Earth conditions. So a gyroscope can keep its angle state relatively the Earth constant if only its main axis is directed parallel to the Earth revolution axis. This gyroscope property cuts down many possible its applications on the Earth as well as in the Space.

Here we suggest a gyro-device named as a giro-dipole consisting of a pair of gyros that has a few associating states with a variable number of rotary freedom degrees (RFD) in range 0-3 or, reversibly, the variable number of rotary restrictions in range 3-0. The gyro-dipole can have no restrictions at all or it can be restricted by inclinations round a single axis, two or three axis's. As researches show, this gives a gyro-instrument opening new additional applications for gyroscopes in various technical branches.

Here are examples of expected gyro-dipole benefiting usage as:

the main part of an indicator of absolute angular shift and rate of revolution of any body relatively inertia space;

the main part of an indicator of universal relative angular shift of any object on revolving surface or orbiting craft;

the main part of control and navigation tools for cars, ships, aircraft, etc.;

reversible stops torques support in mechanical force systems.

### BRIEF SUMMARY OF INVENTION

The general idea of the claimed invention is the obtaining a gyro-device possessing a variable rotary freedom degree (RFD) opening new possibilities for instrumental engineering. For that a couple of gyroscopes named here as gyro-twins are set in common frame by its individual precessing axis's disposed parallel and connected with gears allowing the gyro-twins to precess individually around their axis's but contrary each to other.

### BRIEF DESCRIPTION OF SEVERAL VIEWS OF DRAWINGS

FIGS. 1, 2, 3. Gyro-twins set with its precessing axis's in common frame and tied with gears allowing the gyro-twins to precess individually but only contrary in their precess axles (front, side and above views).

FIG. 4. Dummy gyro-dipole with gyro-twins set hard on a common bar arresting them.

FIGS. 5, 6. Interstate transition maps for the symmetrical and asymmetrical gyro-dipoles.

FIG. 7. A map of generalized states and behavior of the symmetrical (frames 1-3) and asymmetrical (frames 4-6) gyro-dipoles, characterized with a RFD=0-2.

FIG. 8. Diagrams of RFD for a gyro-dipole states: arrested, conflict, locked, accord.

FIG. 9. Gyro-dipole displaying ability to precess when opposite torques are applied to the gyro-twins by simple changing the suspending points.

FIGS. 10, 12. The absolute angular (AA-) shift detector e (front section and above views).

FIG. 11. Scheme measuring revolution rate and also latitude αof some place on the Earth or a planet surface.

FIGS. 13, 14. The relative angular (RA-) shift detector transformed from AA-shift detector (front and above views).

FIG. 15. Using the RA-shift detector for navigating along orthodromes (shortest routs) instead famous known loxodromes.

FIG. 16. Explanation of the AA-shift of 2π during path tracking closed counters drawn on a plane surface.

FIG. 17. Explanation of the AA-shift of <=2π as a result of measuring solid angles by path tracking of their miscellaneous closed counters on sphere surface.

FIG. 18. Using the gyro-dipole stop torque support for deriving rocking energy feeding the boat power supply system.

FIGS. 18(A-B). The gyro-dipole ‘driving’ the boat power plant when rocking (side, rear, and above views).

FIGS. 19. 20. A dense packaged gyro-dipole (side and above views).

FIG. 21. Diagram of passes between gyro-dipole states of 0, 1, 2, 3 rotate freedom (RFD) degrees.

NUMERIC SYSTEM SIGNNG ELEMENTS AND PARTS OF SYSTEMS

| Ten\|_{——————} | _{—————————} | _{——}Units_{———} | _{—————————} | _{—————————} |
|---|---|---|---|---|
| 0:0 | 1- gyro-twin, | 2- gyro-twin, | 3- gear wheel, | 4- gear-wheel, |
| _ 5- drive, | 6- drive, | 7- pinion, | 8- pinion, | 9- angle pick up, |
| 1:0- stop, | 1- cog, | 2- case end, | 3- axle, | 4- axle, |
| _ 5- frame, | 6- case end, | 7- bearing, | 8- insertion, | 9- bar, |
| 2:0- hinge, | 1- hinge stop, | 2- rope, | 3- weight beam, | 4- rope, |
| _ 5- globe, | 6- mirror, | 7- laser source, | 8- receiver, | 9- case, |
| 3:0- bottom, | 1- bearing, | 2- drive, | 3- gear wheel, | 4- cover, |
| _ 5- shaft, | 6- indicator, | 7- window, | 8- clock, | 9- gyro-dipole, |
| 4:0- axle, | 1- frame, | 2- support, | 3- hull, | 4- gear sector, |
| _ 5- bevel gear, | 6- gap hole, | 7- power plant, | 8- floor (deck), | 9- stop, |
| 5:0- latch, | 1- electromagnet, | 2- spline shaft, | 3- hydra cylinder, | 4- drive, |
| _ 5- gyro-shaft, | 6- gyro-case, | 7- gyro-ring, | 8- bridge, | 9- bridge, |
| 6:0- stop-gear, | 1- gyro-compart., | 2- house, | 3- load compart. | 4- sym. plane. |

### LETTER'S DENOTES

Ω—spin rate vector; a—according axis, c—conflicting axis, n—neutral axis; T—torque vector, R—resistance torque vector; P—precession vector; A—accord, C—conflict, and L—locked state of a gyro-dipole; R—resistance force moment against bending or twisting indexed by b or t; RFD—rotary freedom degree; AA—absolute angular, RA—relative angular; => one and [symbol] both ways actions.

### DETAILED DESCRIPTION OF INVENTION

### 1. Gyro-Dipole Conception

### 1.1. Basic Design Claim 1

Gyro-dipole as follows from its name is a gyroscopic apparatus allocated in frame 15 (FIG. 1) and consists of two gyro-twins 1, 2 fixed pivotally in that frame with parallel disposed axles 13, 14 which the gyro-twins can precess around individually contrary each to other. The gyro-twins possess equal angular momentum.

We distinguish two design types of the gyro-dipoles:

with gyro-twins main axis's initially directed coaxial but controversy (in conflict) and named as a symmetrical gyro-dipole;

with gyro-twins main axis's initially directed coaxial and equally (in accord) forming ‘tandem scheme’ and named as asymmetrical gyro-dipole.

On the FIG. 1 we see the symmetrical gyro-dipole. Their main axis's set initially opposite each to other. To convert the symmetrical gyro-dipole to asymmetrical one we need to speed up one of the gyro-twins backward, i.e. to reverse main axis of either gyro-twin. When the main axis's are directed coaxial and equally we have the asymmetrical gyro-dipole with the gyro-twins set asymmetrically.

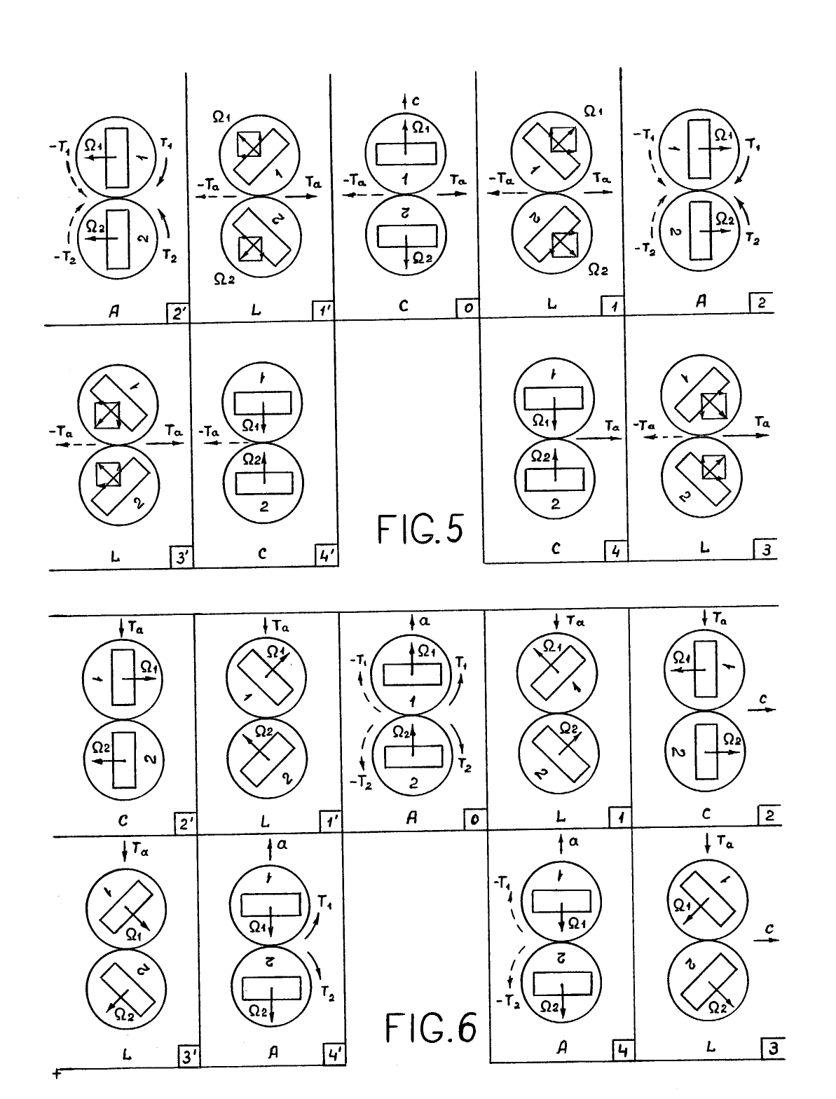

Many of us have being met a dummy gyro-dipole. Let's to see on the FIG. 4. Two gyroscopes 1 and 2 set opposite of their main axis's on a strong bar 19. Why it is strong? After spinning up the gyroscopes 1, 2 can be only enforced to precess together by turning the bar (vector P substitutes the torque vector T). This compelling precession requires the gyro-twins to experience opposite reactive torques T₁, T₂ produced by the bar 19.

They are the bar reaction on gyro-twins attempt to precess when we start to turn the bar 19 with initial torque T substituted soon with the precession vector P (FIG. 4). The bar 19 reacts with the torques T₁, T₂ and experiences contrary torque's from both gyroscopes compelled to precess by the bar turning. The force moments, generated by the gyro-twins and bending the bar 19, are tremendous. This is why the bar 19 and the gyro-twin bearings are to be strong enough and the bar turning may not be fast to avoid a crush.

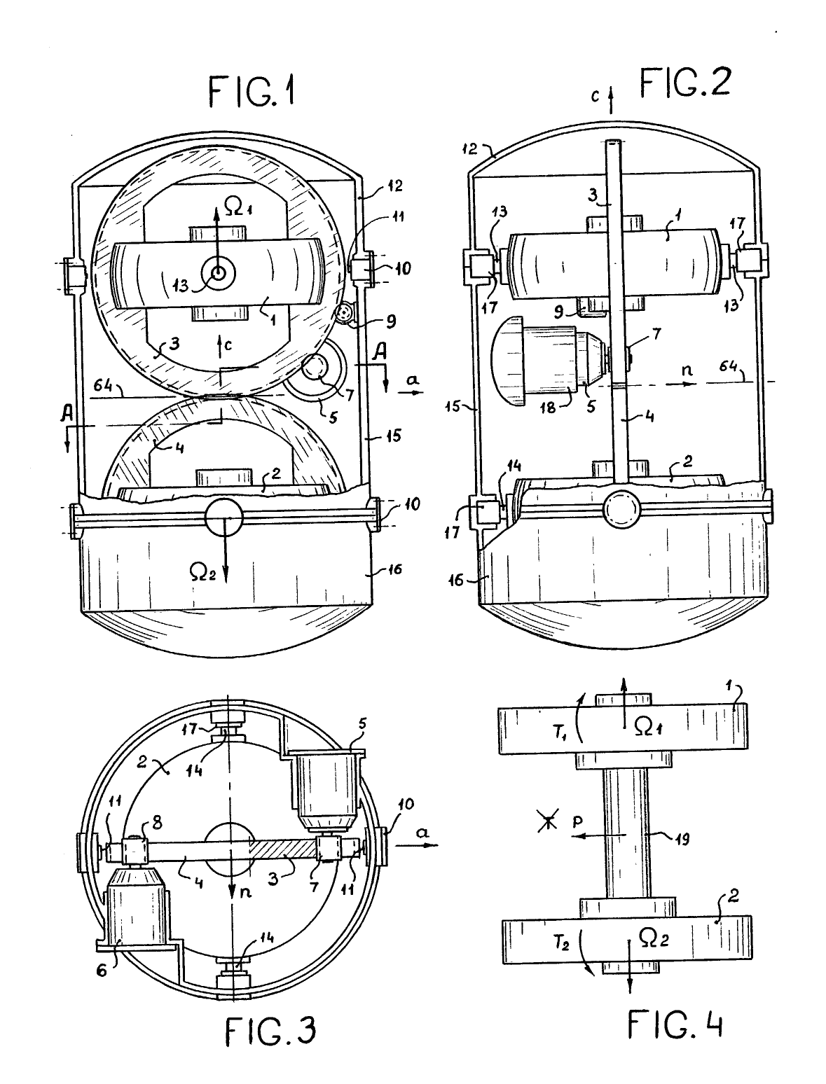

Considered gyroscopes interact between themselves monotony, primitively: they counteract in any turn of any direction. This hides the gyro-dipole visible gyroscopic properties. It is because the bar 19 has constrained their possibilities to resist against any attempt to be tilted. As we can see (FIGS. 1-3) when it is needed our gyro-twins can be set to this state also by electromagnet stops 10 pushing its cogs 11 into gear rings of the wheel 3, 4 causing RFD=3. But the most time they interact through the gear wheels 3, 4, synchronizing their individual behavior displayed as joined opposite precession. Owing of these gear wheels the gyro-twins 1, 2 of the symmetrical gyro-dipole are always disposed symmetrically each to other relatively the plane of symmetry 64 that crosses perpendicular the longitudinal axis of the apparatus (15) in the tangent (engaging) dot of gear wheels.

### 1.2. Basic States of the Gyro-Dipole

### 1.2.1. The Symmetrical Gyro-Dipole

The basic states of the gyro-dipole are represented on FIG. 5 for the symmetrical and on the FIG. 6 for the asymmetrical gyro-dipole. The states are defined by internal mutual position of the gyro-twins able to turn in contrast. Gyro-dipole differs from a conventional gyroscope that can be freely turned about single axis—the main gyro-axis. Our gyro-dipole can be freely turned from initial position also about the second axis named as neutral n and directed to us from the drawing sheet (FIG. 7, frame 1). Individual impending torques eliminate each other trough the common case 15 (FIGS. 1-3). The gyro-twins jointly precess around the neutral axis n owing to the gyro-dipole case creating needed supporting torques R_{b1}, R_{b2}.

The gyro-dipole momentary pictures or frames (FIG. 5) are numbered from 0 to 4 (right transition branch) and from 0 to 4′ (left transition branch). Let's to name the longitudinal axis of the gyro-dipole as a contrary axis c for the symmetrical gyro-dipole (FIG. 5). The axis crossing perpendicular the longitudinal axis in the sheet plane is named as an according axis a for the symmetrical gyro-dipole. It is because the symmetrical gyro-twins jointly turned opposite on angle 90° (each) become accorded, i.e. their main axis's are parallel each to other and also to the according axis a (frame 2 or 2′ of the FIG. 5). This position of the gyro-dipole is named as an accord state (A).

The initially symmetrical gyro-dipole passes from conflict state C (frame 0 of FIG. 5) to accord states A (frames 2 and 2′) by precessing jointly to opposite directions turning their main axis's until they are directed in accord. The precessing is compelled by the torque Ta, applied around the according axis a. If torque Tₐ>0 (directed to right) the gyro-dipole goes to right transition branch through the intermediate state named as the locked state (L) tilting spin vectors Ω₁, Ω₂ to direction of the torque vector Tₙ (FIG. 5, frame 1).

If torque vector T is directed left the gyro-dipole precesses to the left transition branch through another locked state L (frame 1′). We reflect this transition in the table 1 by writing Tₐ [symbol] (P₁, P₂). The arrow shows two directions instead one discussed. It means we can generate also precession of the gyroscopes 1 and 2 around axles 13, 14 (FIGS. 1-3) simply driving them with the drivers 5, 6 and arresting the gyro-dipole relatively the according axis a, that leads to arising reactive torque Tₐ sustaining said precessions P₁, P₂. The precessing can be reversed any time by changing direction of said torque until the gyro-dipole reaches either accord state (A).

The gyro-dipole RFD=1 in accord state. Here the torque Tₐ has not any influence on the gyro-twins because their main axis's are parallel the torque Tₐ. The accord state is very stable: all possible outer effects are not able to disaccord the gyro-dipole. The device behaves as a single gyroscope with double angular momentum. Only internal opposite influences can lead the gyro-twins out of this state.

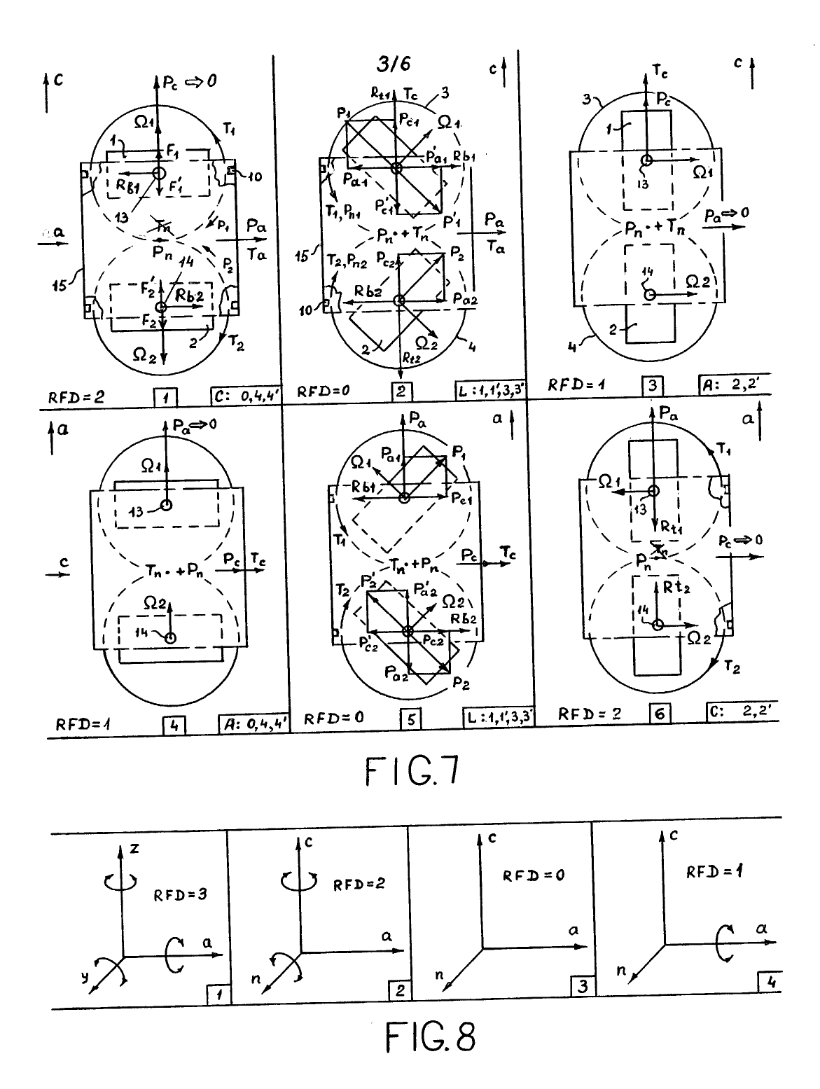

In distinct of it the conflict state is very unstable but it is also very interesting for many new application. Here we are able to turn the gyro-dipole without serious efforts not only around the conflicting axis c that is parallel to the main axis's but also around the neutral axis n. So here the gyro-dipole conserves motionless only around the single axis a (FIG. 8, frame 2). The unit turning ability around the neutral axis n is created with gear wheels 3 and 4 (FIGS. 1-3). They compel the gyro-twins to turn (precess) around the axis n with support of reactive torques produced by the frame 15 as couples of forces F₁, F₁′ in the bearings of axles 13 and F₂, F₂′—in the bearings of axles 14 (FIG. 7, frame1).

If the parallelism of the main axis's disappears, the gyro-dipole transits to the locked state (L) where it is locked relative all three axis's (FIG. 8, frame 3) and so it has RFD=0. In order to keep the gyro-dipole constantly in the conflicting state C we use the automated system eliminating any gyro-twins opposite slopes by applying the needed torque

Tₐ around the axis a with the drive 32 (FIG. 10) using source signal from an optical pickup containing a reflector 2, a source 27 and a receiver 28 (FIG. 10) or from the inductive pickup 9 (FIG. 1).

As we see (FIG. 5) many frames show states of the gyro-dipole with the same essence. The frames 0, 4, 4′ show the gyro-dipole in the conflicting state (C), where RFD=2. The frames 1, 3, 1′, 3′ show the gyro-dipole in the locked state (L), where RFD=0. The frames 2 and 2′ show the gyro-dipole in the according state (A), where RFD=1 (like an ordinary gyroscope). This fact allows to generalize (simplify) the map of the gyro-dipole states (FIGS. 7, 21) distinguishing them only with RFD value.

### 1.2.2. Asymmetrical Gyro-Dipole

Let's to name the longitudinal axis of the asymmetric gyro-dipole as an according axis a as well as the crossing axis lying in the drawing plane—as the conflicting axis c (FIG. 6). The asymmetrical gyro-twins (FIG. 6) turned to angle 90° from according axis a to conflict state (C) direct their main axis's parallel to the conflicting axis c and controversially each to other. Thus the coordinate systems of these different designed gyro-dipoles are shifted to 90°. The third coordinate axis n is neutral and directed from coordinate origin (the wheels tangent point) to us perpendicular to the drawing sheet.

Now we see the gyro-dipoles of the different types are identical when we consider their states and behavior. This means they are different only by the design type. Different constructions allow adapting the gyro-dipoles to different practical conditions.

Conceptual theory of the gyro-dipoles behavior is presented in Appendix A and Appendix B. which may be omitted at the very first reading.

### 2. Instrumental Applications of the Gyro-Dipole

### 2.1. Absolute Angular (AA-) Shift Detector for Geophysics and Geographic Researches

### 2.1.1. Description of the AA-Shift Detector Claim 2

As we have stated before (p. 1.2.1), the gyro-dipole being in the conflict state (the main axis's of the gyro-twins are set parallel and contrary) possesses RFD=2. Thus it resists against turns only about a single axis named as an according axis C. To keep the gyro-dipole in the conflict state (C) we need to prevent the gyro-dipole against any torques Tₐ about the according axis a. This is the only external reason able to lead out the gyro-dipole from the state C. Doing this we control any tiny deflections of the main axis's from the conflicting direction c, i.e. any smallest contrary precessions of the gyro-twins 1, 2.

Here we use the asymmetrical gyro-dipole (FIG. 10) mounted in the outer case 29 with the axle 35 and the couple bearings 31. Any torque transmissions can be directed only from the outer case 29 and they detected by the precession optical pickup consisting of the mirror 26, the projector 27 and the receiver 28. The smallest gyro-twin deflection (precession) is detected by it and an automatic control system eliminates this deflection at a moment with the driver 32 engaged with the gyro-dipole body 15 through the internal gear wheel 33. The driver 32 applies the torque making the gyro-dipoles to precess back to zero.

Notice: Here many different kinds of pickups can be used. One example is the inductive pickup 9 (FIG. 1). It detects small and large deflections of the gyro-twins and it can be used for control the gyro-dipole the reversible torque's stop.

Now we can tilt the AA-shift detector to any side without applying any force moments. However, if we turn our device around the axis a, we find that while the device body is turned the scaled disk 36 is not. It is because the disk is kept hard with the axle or shaft 35 fixed on the asymmetrical gyro-dipole 15 and revolving into the bearing 31. So the disk conserves absolute motionless around the axis a. Comparing the scale on it with the scale on the basis of the window 37 gives the value of absolute angular (AA-) shift of the AA-shift detector body relatively angular motionless disk 36.

### 2.1.2. Detecting the Angular Shift and Revolution Velocity of any Earth Place

Let's set the AA-shift detector vertically in any place θ on the Earth or a planet (FIG. 11). It displays an arising AA-shift Λ(t) between the scaled with the parts of world (FIG. 12) detector body 29 and rotating (along with underlying Earth surface of the particular place θ) absolute motionless case 15 of the inserted gyro-dipole. The shift Λ(t) shows the angle of revolution for t hours. Dividing the shift Λ(t) for any time t by its value we obtain the vertical average absolute angular (AA-) velocity of a place θ:

λ=Λ(t)/t. (1)

The average AA-velocity vector E is directed vertically and arises from place θ where the AA-shift detector set (FIG. 11).

### 2.1.3. Detecting Twisting Surface Oscillation of a Researched Place Claim 3

Differentiating the function Λ(t) we have the instant vertical AA-velocity of the place θ, i.e. λ(t)=Λ′(t). If the place θ does not oscillate rotary or does not tremble rotary then λ(t)=Λ=constant. In this case we observe the pure Earth or planet revolution in the place θ and its revolution rate=λ. But what if the λ(t)≠λ (not equal constant)? In this case we can select an alternating part of the function λ(t) as a following difference:

Δ(t)=λ(t)−λ. (2)

The difference Δ(t) displays twisting oscillation or rotary tremble, which possesses a nature distinguished from uniform Earth (planet) revolution. These oscillations or tremble could be caused by the different reasons, for example, an earthquake, explosions, etc.

### 2.1.4. Detecting Bending Surface Oscillation in Some Place of the Earth (Planet)

To detect the Earth revolution around a meridian we need to orient and to fix hard the AA-shift detector directing the according axis a horizontally along a meridian instead vertically as shown (FIG. 11). In this case our AA-shift detector actually detects an absolute angular inclination of the Earth surface in the point θ relatively the ‘motionless’ Universe. The AA-shift detector displays an AA-shift L(t) between the outer body 29 inclined by the Earth surface and the motionless gyro-dipole body 15.

Rewriting the formulas (1) and (2) for the meridian Earth (planet) surface revolution we obtain:

a meridian horizontal AA-velocity of the Earth surface in the place θas follows:

ψ=L(t)/t. (3)

a surface meridian AA-velocity fluctuation function in place θ as follows:

δ(t)=l(t)−ψ, (4)

where: l(t)=L′(t)—the first derivative of the meridian AA-shift function L(t). The function δ(t) gives also much information about possible ground surface waves produced by different reasons as:

periodical deformations produced by gravity of the Moon;

earthquakes;

explosions;

transportation and industrial vibrations.

### 2.1.5. Determining Spin Rate and Latitude of Any Point of the Earth (Planet) Claim 4

Assume we priory know the Earth (planet) revolution rate ωₚ. The latitude of a place, where the AA-shift detector is set vertically with its according axis a, is defined as either

α=arc sin(ω/ωₚ), or (5)

α=arc sin(Λ/Λₚ), (6)

where the Λₚ is the absolute angular shift displayed by the AA-shift detector set vertical on the pole; it is clear that Λₚ=2π for a ‘sidereal day’=23 hours, 56 minutes, 4 seconds ([1], page 917) the Earth accomplishes whole turn relatively the motionless axis a.

The latitude α of a place θ can be determined also by any other formulas:

α=arc cos(ψ/ωₚ), (7)

α=arc cos(L/Λₚ), (8)

where: ψ—meridian horizontal AA-velocity of the Earth surface in place θ calculated with formula (3);

Λₚ—the absolute angular shift displayed by the AA-shift detector set vertical on the pole or calculated using the Earth (planet) revolution rate ωₑ and time t by the formula:

Λₚ=ωₑ·t. (9)

If we don't know priory a revolution rate we need to use the AA-shift detector twice during the equal time periods t. The pole AA-shift is determined in this case as

Λₚ=√(Λ\hat{ }2+L\hat{ }2). (10)

### EXAMPLE 1

During ‘a sidereal day’ the AA-shift detector set with axis a vertically displays the AA-shift=200°, i.e. 0.017453 radians* 200=3.4906 radians. So Λ/Λₚ=3.4906/2π=0.55555. The latitude α=arc sin(0.55555)=0.589 radians or α=33°44′56″.

### EXAMPLE 2

During time t=2 hours the detected AA-shift around the vertical axis is Λ=0.65 radians and the detected AA-shift around the meridian axis is L=0.37 radians. Respectively the AA-shift around the planet axis is Λₚ=√(0.65\hat{ }2+0.37\hat{ }2)=0.748 radians. The planet revolution rate is ωₑ=0.748/2=0.374/hour. The planet makes whole turn during the period=16.8 hours. The latitude of the place where the AA-shift detector set is α=arc sin(Λ/Λₚ)=arc sin(0.65/0.748)=1.053145 radians or α=60°20′30″.

These examples show how are powerful the methods determining the Earth (planet) rotation rate and a latitude of any place on it.

### 2.2. Timers and Navigational Gyro-Instruments Built on the Gyro-Dipole Base

### 2.2.1. Our Population Does Not Stop Wondering to New Clock and Watch Models

People really like to see and use them. There is the additional original model of the timer. Let's to scale the gyro-dipole cover 34 as a clock dial plate for twelve hours. If we put between the shaft 35 and the disk 36 (FIG. 10) gearbox with the gear ratio 2π/Λ(12 h.) then the clock arrow set on the gearbox output shaft (instead the disk 36) shows current time. The arrow should be initially set to the current hour mark.

### 2.2.2. Universal Relative Angle (RA-) Shift Detector Claim 5

Because the gyro-dipole does not turn around its axis a while the body 29 (FIG. 10) of the follows the Earth revolution, if it is mounted on the ground, then the gyro-dipole disk indicator 36 apparently is slow from said body 29. We can fix this lag easy by putting clock mechanism 38 (FIG. 13) between the motionless shaft 35 and the indicator disk 36. This clock should run with rate Λ_{α}(t)/t in order to rotate the disk 36 synchronically with the place rotation where the gyro-dipole is.

After this reconstruction the disk virtually conserves parts of world orientation of this real place even though we separate the gyro-dipole from land and do not care about the body 29 orientation. The transformed AA-shift detector becomes now a RA-shift detector sustaining virtually the needed world parts orientation right for this particular place (FIG. 14). We understand that the gyro-dipole axis's c and n apparently ‘turn to right’ around the axis a but the indicator card 36 is kept properly, right by the clock mechanism 38 (FIG. 13).

In this embodiment the RA-shift detector is very nice navigating instrument for local applications used in the nearest environs.

For long distance travelling by a boat, a plane or a car we need additionally to reconstruct this RA-shift detector to the Universal RA-shift detector because run rate of the embedded clock needs to be dynamically adjusted for revolution rate of the Earth in each particular place. With this condition the Universal RA-shift detector behaves on a spinning globe similar as the AA-shift detector behaves on the motionless sphere (p. 2.3), i.e. if the globe moves in Space without any rotation.

First of all it does not detect any angular shift if it path track along the geodesic line (orthodrome). So the Universal RA-shift detector is the precise indicator of a course along orthodromes. With the Universal RA-shift detector we always know the shortest route between any points on the Earth (planet surface).

### 2.2.3. The Shortest Navigation Routes Claim 6

Assume (FIG. 15) the coordinates of the initial point A (latitude, longitude) are (αₐ,λₐ)° and the coordinates of the target point B are (α_{b}, λ_{b})° measured in degrees. Let's take colatitudes of latitudes α calculating them by the formula:

β=π/2−α. (11)

The angular length of the shortest route AB is defined according [2, page 493] by Cosine rule for spherical triangle sides as follows:

cos(AB°)=cos(βb)cos(βa)+sin(βb)sin(βa)cos(λb−λa). (12)

The Sine rule [page 348 of 3] gives an expression for Sine of the course k as follows:

sin(k)=sin(λb−λa)sine(βb)/sin(AB°). (13)

Now the course k, which should be taken initially from the point A in order to use the shortest route, is defined by the formula:

k=arc sin(k). (14)

The RA-shift detector keeps the taken direction perfectly without any deflections. As we see (FIG. 15), the shortest course changes constantly relatively the northern pole. But we care about our shortest route lied along the orthodromes and for us now the exact location of the North is not important in compare with the course targeting directly to the point B or from the B to the point C (the second route). We need only plotting our path on the map to find current latitude in order to correct periodically the clock run rate. Modern navigation systems can do it permanently and automatically. The routes along loxodromes L supported by a compass with keeping constant course χ looks awful now. It is clear this RA-shift detector and the method of the navigation with it along the shortest routes is applicable for any kind of vehicles (ships, airplanes etc.)

### 2.3. Solid Angles Measurements Claim 7

### 2.3.1. General Consideration

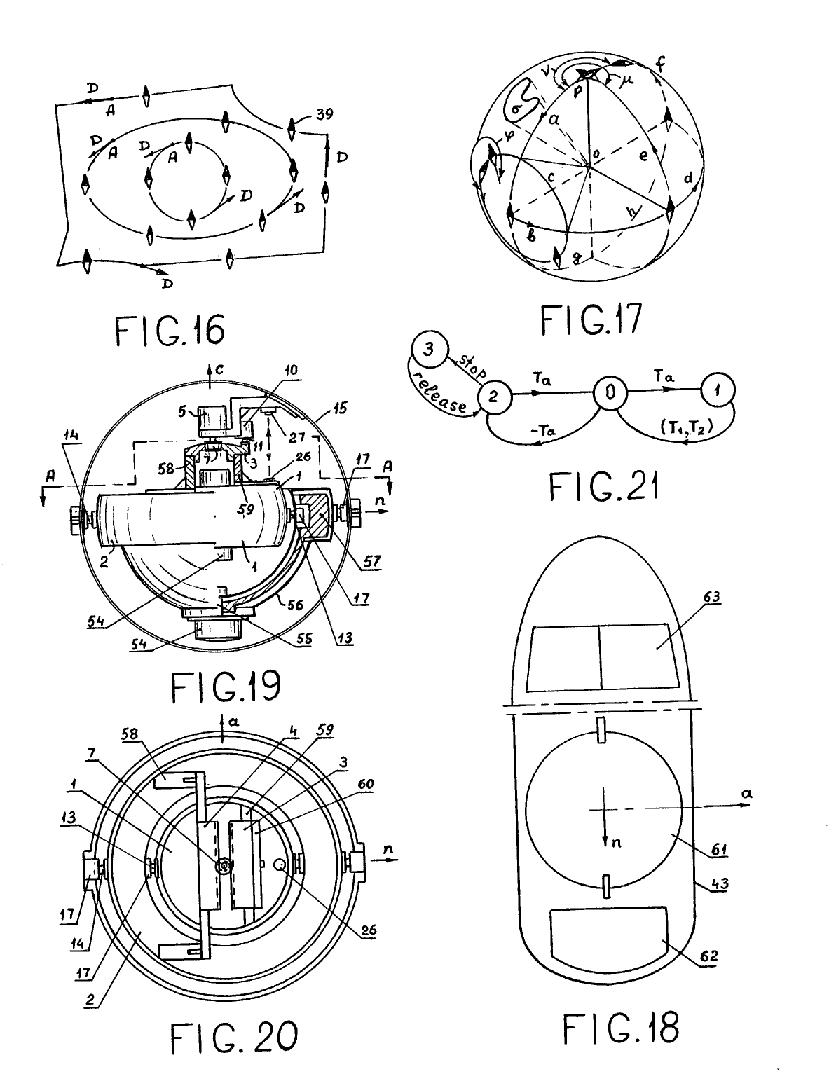

Let's to draw a rhomb-arrow on the surface of the indicator disc 36 of the AA-shift detector (FIG. 10). And let's the rhomb-arrow has the similar view (FIG. 16) as the arrow of a conventional magnet compass. The AA-shift detector keeps the rhomb-arrow motionless in Space coordinates. Now let's to drag the AA-shift detector along different counters drawn on the motionless plane (FIG. 16). Assume the body 29 of the AA-shift detector has arrow mark D showing direction of path tracing. The arrow D accomplishes whole turn while the AA-shift detector is tracing any shown counter (FIG. 16). Every time the rhomb-arrow on the motionless disk 36 lags with angle 2π.

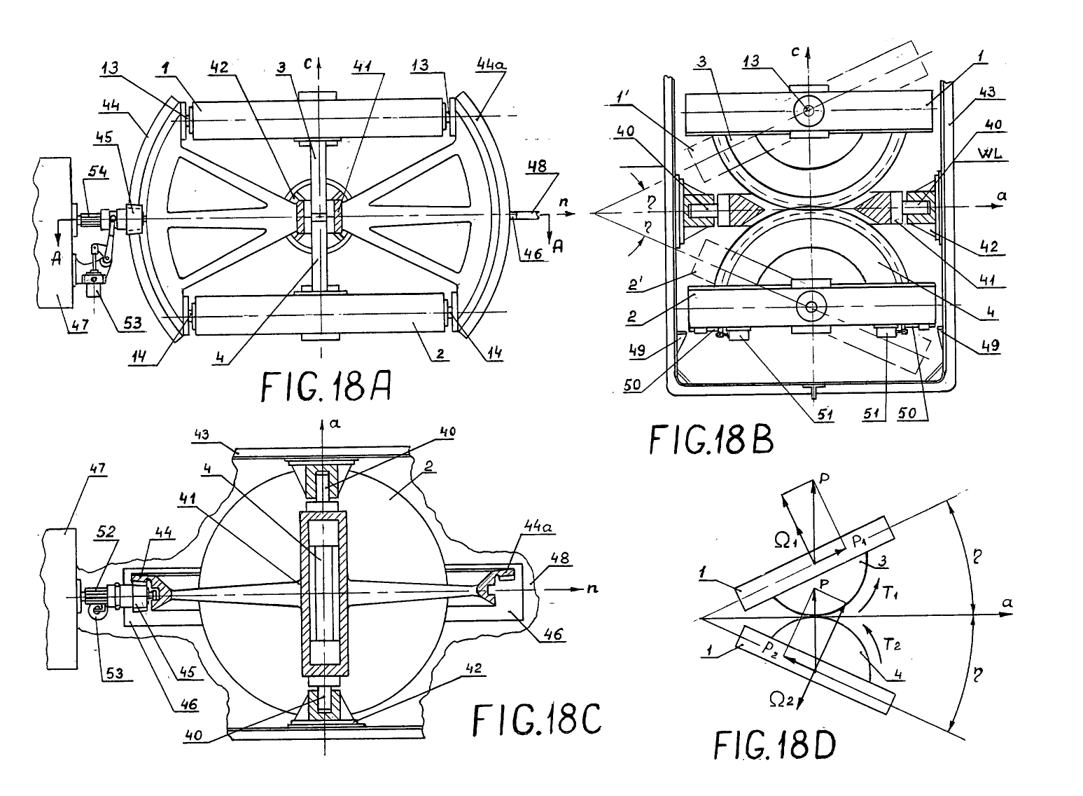

If we draw counters on the sphere (FIG. 17) we see much interesting picture. Let's to drag the AA-shift detector along the counter <a-b-c-a> from the initial pole P. As usual the instrument body 29 has the arrow mark D following to the path tracing. At route end the arrow mark D shows the initial direction from the pole P as shown by the path arrow <a> accomplishing as we count (90°+90°+90°)=270°. Mean while the rhomb-arrow does not do any turn (FIG. 17) lagging on the angle μ=270°.

Let's now to track the path <a-b-d-f-a>. The arrow mark D turn angle (90°+90°)=180°. In the same time the rhomb-arrow makes the angle lag ν=180°. At least let's to track the path <a-g-h-f-a>. Both arrows turn zero angle.

Now we do couple of conclusions:

The first. The AA-shift detector determines value φ of AA-shift made by the AA-shift detector body 29 (FIG. 10) during path tracking.

The second. The solid angle Φ encompassed by any counter on a sphere follows as:

Φ=2π−φ. (15)

It is true because the solid angle encompassed by the whole sphere equals to 4π. The solid angle encompassed by the hemisphere equals to 2π. The solid angle encompassed by the sphere quarter equals to π. The solid angle encompassed by the 8-th part of whole sphere equals to π/2. And we have the same results using the formula (15).

So we have a method measuring solid angles encompassed by any spherical counter, for example, the counter <c> or the other counter σ (FIG. 17). To measure a solid angle we need to track it by the AA-shift detector turning its body according the counter curvature taking the total tracking angle φ showing by the AA-shift detector indicator. Then we calculate the desired angle with the formula (15).

### 2.3.2. Essential Notices

Notice 1: When we measure angles turned by the AA-shift detector during the Earth (planet) revolution (FIG. 11) we can do also measure of a solid angle encompassed by some small circle drawn by the Earth (planet) revolution on the latitude of the measurement. The only inconvenience is the great duration of this measurement, which equals to the ‘sidereal’ day [1].

Notice 2: Astronomers can use the AA-shift detector also for measure solid angles countered on the firmament. They need only remember that the AA-shift detector's body should turn together with directing line tangent to the counter as well as the AA-shift detector should be maintained on a telescope or same arm directed to the haven like radius-vector.

Notice 3: The AA-shift detector drawing along a great circle or its arc of any length (orthodromes) does not detect some angle shift.

Notice 4: The AA-shift detector drawing along curve or open polygon displays difference between finish and initial angle position of the AA-shift detector on the surface.

Notice 5: Sphere rotation changes an angle position of the AA-shift detector. To compensate rotating of the sphere we use the clock revolving the indicator disk 36 with the rate of the revolution in this particular place associated with its latitude. We name the adapted AA-shift detector as the RA-shift detector.

Notice 6: If the run rate of the clock, compensating the Earth (planet) revolution, is dynamically adjusted to the latitude where the RA-shift detector is then it is named as Universal RA-shift detector and it functions as the AA-shift detector on the motionless sphere.

### 3. Stabilizing Force Moments and Stop Torques Sustaining Applications

### 3.1. Wave Energized Gyroscopic Driver for Marine Power Plant Claim 8

The patent application “Power floating production and ship propulsion supported by gyroscope and energized by seas” (application #09/777.846 from Feb. 07, 2001) has developed ideas to use a gyroscope as a gyroscope stop support (torque fulcrum). This stop made as a gear sector is run along reversibly to both sides by a driving mechanism when it swings together with a boat hull on waves. Obtained solution requires to keep the gyroscope main axis so as it has the minimum average deflection from vertical. The deflections constantly arise owing to the Earth revolution. This problem is solved by the automatic precession compensating system.

The gyro-dipole was created initially just for overriding this problem. The giant gyro-dipole is set in boat machine compartment closed by the cover 61 (FIG. 18). Its axis's are directed: c—vertically, n—longitudinally, a—side-ways. Three views (side, rear, above) of the giant force gyro-dipole are shown on the FIGS. 18(A, B, C). Gyro-twins 1, 2 are set with axis's 13 and 14 in the frame 41 allowed to swing on the axles 40 but really staying motionless when the gyro-twins spin. Instead the deck 48 and the power plant 47 swing together with rocking boat hull. This enforces the bevel gear 45 to run along the gear sector 44 and to drive reversibly the power plant 47.

Any time, when the gyro-dipole axis c deflects from the vertical too far, the gyro-twins can be arrested with the latches 50 shifted by the electromagnets 51 to the side ways to engage with the stops 49. For the short time the clutching mechanism (45, 53, and 54) disconnects the power plant from the gyro-dipole thus the boat hull aligns own and gyro-dipole positions. This solution does not require any additional force system compelling the gyroscope to precess in order to eliminate undesired gyroscope tilting.

When maneuvering it is recommended to arrest the gyro-dipole as well because the gyro-dipole in different locked states (FIG. 18D) reacts different on the same maneuver. In drawn particular state the left turn forcing the precession P with the projections P₁, P₂ which require supporting passive (dead) torques T₁, T₂ applied from the hull 43. But we know the left turn tilts the boat hull 43 to right excluding the torque support and so makes the left turn problematic in this situation. But if the gyro-twins change their position for opposite then the left turn is accomplished well. Whole maneuver is produced with dashes. If the gyro-twins internal precessions are small it is possible to maneuver with some dashes.

Any way the gyro-dipole, used as described above, opens inexhaustible source of gratuitous energy from seas. And it is clear any fleets and navies are the nearest consumers of this energy.

### 3.2. Other Force Applications for the Gyro-Dipole

The gyro-dipole set hard by its axis a along side of a boat or a ship can perfectly stabilize it against rolling.

The gyro-dipole, set by its axis a coaxial with a drill axis, can keep heavy drills steady instead manual support. For that the drill should work in reversal mode of operation. This requires a special bit able to work revolving reversibly. It is true also for sink a borehole.

### 4. Gyro-Dipole Dense Packaging Claim 9

The gyro-dipole lay outs (FIGS. 1-3; 18A-C) presented earlier can be changed with more density arrangement (FIGS. 19, 20). For that we insert one gyro-twin to another. The lower gyro-twin 2 becomes the outer gyro-twin set with its axles 14 into the bearings 17 mounted in the spherical case 15 coaxial with the neutral axis n. When the gyro-twin 2 precesses it precesses around the axis n. The case 56 of this gyro-twin 2 is made hemispherical and it contains bearings 17 for the axis 13 of the gyro-twin 1 (the former upper gyro-twin), which is coaxial with the axis n as well.

The constructive peculiarities can differentiate inertia moments J₁, J₂ of the gyro-twins, but we need to keep their angular momentums equal. It is enough to keep their angular velocities Ω₁, Ω₂ in the correlation:

Ω₁/Ω₂=J₂/J₁. (16)

The gyro-dipoles interact each with other through bevel gears 3, 4 and intermediate bevel gear 7, which is free if the drive 5 is in idle mode of operation. If we need to apply torques to the gyro-twins 1, 2 analogous to the torques we applied to them with gear 5 earlier (FIG. 1) then we switch on the drive 5 (FIG. 19).

In order to arrest gyro-twins we use the electromagnet stop 10 pushing its cog 11 into cylindrical cutting on the gear sector 3. Both gear sectors 3, 4 are mounted on their gyro-twins with the bridges 58, 59 allowing maximum relative motions for the gyro-twins. Gyro-dipole also has the optical system detecting any deflection of the gyro-twins from the conflicting axis c.

It is clear that the dense gyro-dipole (FIGS. 19, 20) can be set inside any, possibly spherical outer case to form the AA-shift detector as well as the Universal RA-shift detector.

### Technical Literatures

[1] The Oxford Companion to the Earth. Oxford University Press Inc., New York, 2000.

[2] Jan Gullberg. Mathematics from the Birth of Numbers. W. W. Norton & Company, Inc., New York, 1996.

[3] D. A. Brannan & others. Geometry. Cambridge university press. 1999. Page 347.

### Appendix A

Theoretical basis for the symmetrical gyro-dipole behavior.

### 1. Conflicting State (RDF=2)

### 1.1. Internal Behavior

### 1.1.1. Axis c

Let's to see the symmetrical gyro-dipole behavior under outer torques. The compressed map of the symmetrical gyro-dipole states (FIG. 7, frames 1-3) shows schematically the unit layouts and its behavior in the states (frames 1-3). The initial state is shown on the frame 1. In this state the gyro-dipole resists only against torque ±Ta. Others torques can not be applied because the gyro-dipole does not resist against them. Instead it freely turns around conflicting axis c or around the neutral axis n.

### 1.1.2. Axis n

The turn around the neutral axis n realizes as active precessing Pn both gyro-twins around the neutral axis n. The gear wheels 3, 4 (FIG. 7, frame 1) and axles 13, 14 experienced the reactive anti bending moments Rb1 and Rb2 from the frame 15 support this precession.

The precession vector of Pn directs to us from drawing sheet. The tangent dot of gears denotes it. The attempt to precess expresses initially as some torque Tn causing the gyroscopes to precess their main axis's around the accord axis a to be parallel to it. But this initial probe (attempt) meets constrains of the bearings imbedded into the frame 15 reacting back on the axles 13 and 14 with two couples of forces (F1, F1′) and (F2, F2′) applied respectively to opposite of the axles ends. So the frame 15 reacts with anti bending force moments Rb1 and Rb2 applied to the upper and the lower gyros-twins 1, 2. This is why the precession Pn follows substituting initial torque Tn.

### 1.1.3. Internal Axis's

If we apply the individual torques T₁, T₂ to gyro-twins 1, 2 with the drivers 5, 6 (FIGS. 1-3) the gyro-dipole precesses around the axis a. The same resultant we have arresting the gyro-twins with the stops 10 getting reactive torques T₁, T₂ from them when we actively turn (precess) the gyro-dipole with the vector Pₐ around the axis a.

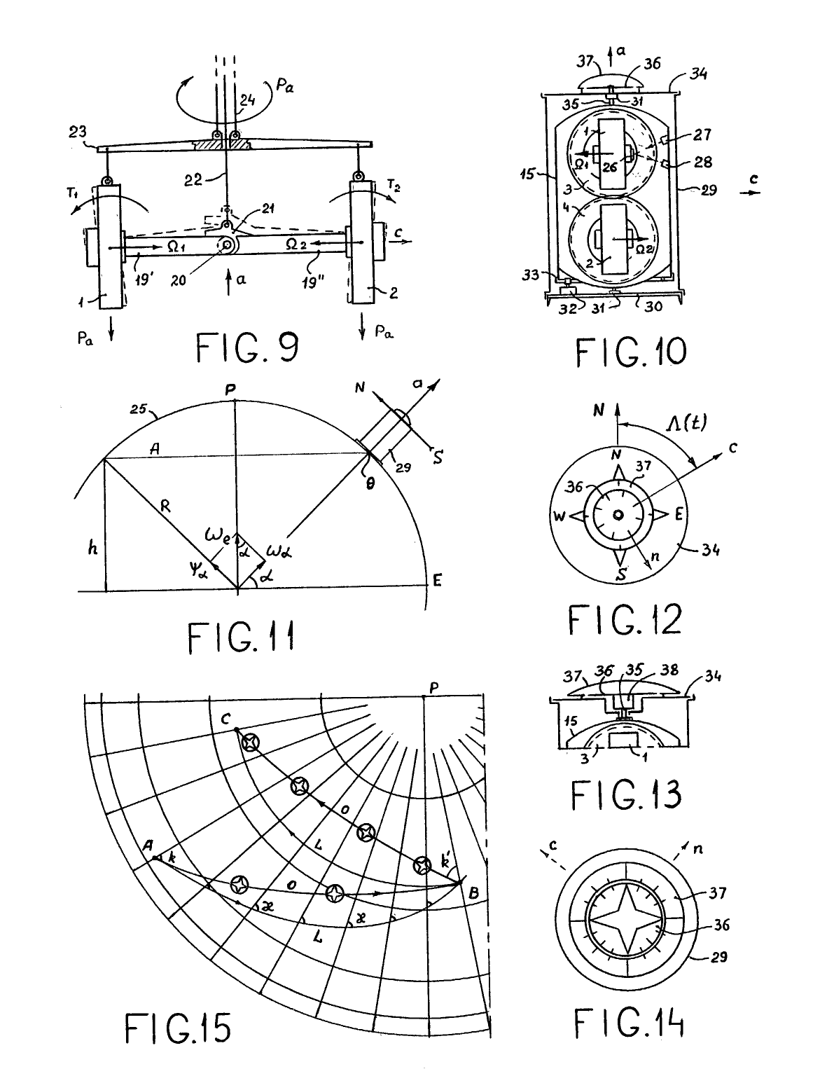

Notice: If the gyro-dipole is not arrested then applying individual balanced torques T1, T2 (FIG. 7, frame 1) to the gyro-twins 1, 2 enforces the visible precession Pa around axis a as if without visible external reasons (FIG. 9).

### 1.2. Interstate Transitions

### 1.2.1. Axis a and Transitions from the Conflict State C (RFD=2)

In order to get out of this state we need to apply actively the torque Ta around the according axis a causing contrary gyro-twins precessions P1, P2 transiting the gyro-dipole to the ‘locked’ state L with RFD=0 (frame 2). In this state we can not directly turn the gyro-dipole around any axis without serious efforts. In the table 1 the ways transiting from the state with the RFD=2 are shown as formula Ta [symbol] (P1, P2) uniting two ways of the transition. According the first one we apply the active (alive) torque Ta resulting to the passive contrary gyro-twins precessions P1, P2. The gyro-dipole leave the conflict state if the gyroscopes are no longer orient their main axis's mutually parallel. They can transit from said state to either side. In both cases the gyros-twins keep their main axis's deflected from the conflicting axis c on an angle ν (0°<ν<90°).

### 1.2.2. Internal Axis's

According the second way of the transition we apply the active precessions P1, P2 requiring the passive (dead) reactive torque Ta. So the second way requires the presence of some restriction of the turns around the axis a causing appearance of said reactive torque

### 2. The Locked State (RFD=0)

### 2.1. Internal Behavior

### 2.1.1. Axis c

This state starts from even small contrary inclinations (precessions) of the gyro-twins 1, 2 from position parallel to the axis c. As shown in the frame 2 (FIG. 7), owing to the gear wheels 3, 4 gyro-twins turn symmetrical contrary each to other. Their spin vectors Ω1, Ω2 have now horizontal projections cutting off the rotary freedom (RFD=0). The turns around any axis's are possible only as passive precessions resulted by respective torques applying. When we do it around the conflicting axis c (frame 2 of the FIG. 7), the torque Tc causes gyro-twins to turn their vectors Ω1, Ω2 to the same direction as the torque Tc. They can not precess separately because of the gears 3, 4 engagement. However, they can precess jointly around the neutral axis n with precession rate, shown by the vector Pn directed to us from the sheet and designed as the tangent dot of the gear wheels.

TABLE 1
Table of stationary states and interstate transitions for symmetric
gyro-dipole.

| RFD | States of gyro-dipole characterized with RFD number | | |
|---|---|---|---|
| or state | 2 = conflict | 0 = locked | 1 = accord |
| 2 = | Pc [symbol] 0, | Ta [symbol] (P1, P2); | |
| conflict | Pn [symbol] (Rb1, Rb2); | | |
| | Pa [symbol] (T1, T2); | | |
| 0 = | Ta [symbol] (P1, P2); | Tc [symbol] Pn, | Ta [symbol] (P1, P2); |
| locked | | Tn [symbol] (Pc, Rb), | |
| | | (T1, Pn1; T2, Pn2) [symbol] (Pa, Rt); | |
| 1 = | | Start with (T1 ,T2) resulting | Pa [symbol] 0, |
| accord | | (P1, P2) [symbol] Rt; | Tc [symbol] Pn, |
| | | | Tn [symbol] Pc. |

Backward action happens if we restrict possible turning around axis c and turn gyro-twins around the axis n actively compelling the gyro-dipole to precess.

### 2.1.2. Axis n

Applying the torque Tn (FIG. 7, frame 2). The vector Tn is shown by the sign “+” meaning that the vector is directed from us to behind the sheet and trying to revolve clockwise. Reacting the gyro-twin 1 try to process with the vector P1 projected vertically as Pc1 and horizontally as Pa1. Simultaneously the gyro-twin 2 try to precess with the vector P2 projected vertically as Pc2 and horizontally as Pa2.

Projections Pc1 and Pc2 don't meet any resistance and the gyro-dipole starts to precess around the axis c with the rate Pc=Pc1=Pc2. The projections Pa1, Pa2 directed opposite each to other. So they meet reactive anti bending resistance moments Rb1 and Rb2 applied in bearings 13, 14 as couples of resisting forces. The torques Rb1 and Rb2 enforce the gyro-dipole to precess coincide with the applied initial torque Tn i.e. clockwise. It is an addition to the precession Pc around the axis c. So the gyro-dipole displays complicated processing behavior when the outer torque Tn is applied to the gyro-dipole around the neutral axis n.

### 2.1.3. Internal Axis's

Apply individual balanced torques T1, T2 with the drivers 5, 6 (FIG. 7, frame 2) to the gyro-twins 1, 2 enforces the visible precession Pa around axis a (without any state changing). The torques T1, T2, first, try to generate gyro precessions P1′, P2 (frame 2) projected horizontally (axis a) as Pa1′, Pa2, and vertically (axis c) as Pc1′, Pc2. Because Pc1′ and Pc2 are directed contrary, they meet anti twisting resistance torques Rt1, Rt2 directed opposite them respectively. These torques cause additional internal gyro-twins precessions around axis n singed as arc arrows Pn1 and Pn2.

The anti twisting moments, issued as reaction Rₜ of the case 15, support transferring the internal torques T1, T2 caused by the drivers 5, 6 to the outer precession Pa. The precessions Pn1 and Pn2 can bring the gyro-dipole back to the conflict state C where the internal torques T1, T2 can not enforce individual precessions Pn1 and Pn2 because precessions components Pc1′, Pc2 become zeroes and do not meet anti twisting torques Rt1, Rt2.

### 2.2. Interstate Transitions

### 2.2.1. Axis a and Transition from the Locked State

In order to pass through and to get out of the locked state we need to apply actively the torque Ta around the according axis a causing contrary gyro-twins precessions P1, P2 transiting the gyro-dipole through the ‘locked’ state with RFD=0 (FIG. 5, frame 1). In this state we can not directly turn the gyro-dipole around any axis without serious efforts. In the table 1 the ways transiting from the state with the RFD=2 are shown as formula Ta [symbol] (P1, P2) uniting two ways of the transition.

According the first one we apply the active (alive) torque Ta resulting to the passive contrary gyro-twins precessions P1, P2. The gyro-dipole passes the locked state if the gyros-twins had precessed their main axis's mutually parallel and coincide or controversy (if moving back). They can transit from said state to either side moving their main axis's to the conflicting axis c (back) or to the according axis a (forward).

According the second way of the transition through and out of the locked state (RFD=0) we need to apply the active precessions P1, P2 with the drivers 5, 6 (FIG. 1) requiring to have the passive (dead) reactive torque Ta. So the second way requires to arrest the gyro-dipole around the according axis a.

### 3. The Accord State (RFD=1)

### 3.1. Internal Behavior

### 3.1.1. Axis c

When after processing contrary the gyro-twins are oriented parallel and coincide, we see the gyro-dipole in the according state. Any attempt to carry it out of this state with outside effort is unsuccessful. The attempt to revolve the gyro-dipole around the axis c with the torque Tc (FIG. 7, frame 3) causes precessing gyro-dipole around the axis n with processing rate Pn shown as the gears 3, 4 tangent dot. This means the vector Pn orient to us from the drafting plane.

### 3.1.2. Axis n

Attempt to revolve the gyro-dipole around the neutral axis n with the torque Tn (shown as “+” because directed from us to behind of the drafting plane) causes precessing Pc of the dipole around the axis c. So the behavior of the gyro-dipole in accord state is remembering the behavior of ordinary gyroscope. It is because sum angular momentum of both gyro-twins results that they behave as a single gyroscope.

### 3.1.3. Axis a

The torque Ta can't be applied because the gyro-dipole in this state does not resist against revolving around the axis a. So all outside actions do not change the according gyro-dipole state. Applying internal torques T1, T2 to gyro-twins is the only way to bring the gyro-dipole out of the accord state (A).

### 3.2. Interstate Transitions

The single variant leading to change the gyro-dipole state is the applying to the gyro-twins individual opposite torques with the drivers 5, 6 (FIGS. 1-3). Meeting impossibility to precess around the axis c because contrariety of the needed precessing vectors the gyro-twins experience anti twisting resisting (dead) torques Rt. This torques allows the gyro-twins to precess under the drivers 5, 6 actions. So the gyro-dipole leaves the accord state by this way and transits to the locked state (L).

### Appendix B

Theoretical basis of the asymmetrical gyro-dipole behavior.

The FIG. 6 illustrates transitions between states of the asymmetrical gyro-dipole and the FIG. 7 (frames 4-6) illustrates its generalized states and internal behavior. Results of its description with the formulas shown in the table 2. Everything is identical for both gyro-dipole designs except quality of the resistance torques Rb and Rt. In tables 1 and 2 (sells 0:0 and 1:0) these torques exchange indexes. It is explained by different designs of the gyro-dipoles.

TABLE 2
Table of stationary states and interstate transitions for symmetric
gyro-dipole.

| RFD | States of gyro-dipole characterized with RFD number | | |
|---|---|---|---|
| or state | 2 conflict | 0 locked | 1 accord |
| 2 | Pc [symbol] 0, | Ta [symbol] (P1, P2); | |
| conflict | Pn [symbol] Rt, | | |
| | Pa [symbol] (T1, T2); | | |
| 0 | Ta [symbol] (P1, P2); | Tc [symbol] Pn, | Ta [symbol] (P1, P2); |
| locked | | Tn [symbol] (Pc, Rt), | |
| | | (T1, P1; T2, P2) [symbol] (Pa, Rb); | |
| 1 = | | Start with T1, T2 | Pa [symbol] 0, |
| accord | | resulting | Tn [symbol] Pc, |
| | | (P1, P2) [symbol] Rb; | Tc [symbol] Pn. |

What I claim as my invention is:

1. Gyroscopic device (a gyro-dipole) and consisting of two gyroscopes (gyro-twins) with equal angular momentum set in a common case pivotally by its parallel disposed axles allowing the gyro-twins to precess contrary via engaged gears attached to them; the gyro-dipole possesses variable rotary freedom degree (RFD) from 0 to 3; RFD=2 enables the gyro-dipole freely to swing about two orthogonal axis's while the 3-d axis is stable, motionless.

2. Absolute angular (AA-) shift detector with gyro-dipole (claim 1) of RFD=2 set by its motionless axle into frame and used as a sense element determining AA-shift of the underlying surface (the Earth, planet, etc.) by comparing the new frame position relatively stable gyro-dipole case; to eliminate any external disturbances the gyro-dipole is equipped by an automatic system compensating it.

3. Method detecting twisting as well as bending surface deforming oscillations of the surface of an Earth (planet) place using the AA-shift detector set by the motionless axis on the surface respectively vertical or horizontal (coaxial to a meridian).

4. Method determining the Earth (planet) total spin rate, vertical and horizontal components of it, and latitude of a place; the method uses the vertical and horizontal (coaxial to a meridian) surface AA-shifts Λ and L growing for some time t and measured with the AA-shift detector (claim 2).

5. Universal relative angular (RA-) shift detector made of a AA-shift detector (claim 2) by adding a clock mechanism (adjustable with a place latitude) connecting the gyro-dipole motionless axle and dial disk that eliminates any lag between the disk and the place where the universal RA-shift detector is; said detector behaves on spinning sphere similar as the AA-shift detector on,the motionless sphere.

6. Method using the universal RA-shift detector (claim 5) for navigation along the shortest routes (orthodromes) while the universal RA-shift detector displays any carrier's velocity angular shift from the orthodrome so facilitating the shift elimination.

7. Method measuring solid angles countered on either motionless or spinning sphere by path tracking the solid angle counter on a sphere respectively with absolute (claim 2) or universal relative angular shift detectors (claim 5) and calculated as (2π−φ), where φ is a result of measuring.

8. Method using the gyro-dipole (claim 1) a dynamic reversible torque stop sustaining functioning of different kind reversible drives deprived of a stationary support, for example, a wave energized boat power plant rolls its driving gear reversibly about the gear sector kept motionless by the gyro-dipole frame as the dynamic stop for the gear.

9. Method of asymmetric gyro-dipole dense packaging where one gyro-twin inserted into the second which combines a flywheel ring with hemispherical hub; precession axles of the both gyro-twins are disposed coaxial and engaged via their parallel bevel gear sectors and intermediate bevel gear; the last one is able also to transmit internal torques from a drive to both gyro-twins for the rotary freedom degree control.
